(19) United States
(12) Patent Application Publication
(10) Pub. No.: US 2020/0074518 A1
(43) Pub. Date: Mar. 5, 2020

(54) DIGITAL DATA MANAGEMENT

(71) Applicant: BLOCKLYNCS LLC, Round Rock, TX (US)

(72) Inventors: Selvanathan Kumaraswamy, Round Rock, TX (US); Ravindraraj Ramaraju, Round Rock, TX (US)

(73) Assignee: BLOCKLYNCS LLC, Round Rock, TX (US)

(21) Appl. No.: 16/546,154

(22) Filed: Aug. 20, 2019

Related U.S. Application Data
(60) Provisional application No. 62/723,754, filed on Aug. 28, 2018.

(51) Int. Cl. G06Q 30/06; G06Q 20/12; H04L 9/06

(52) U.S. Cl. CPC G06Q 30/0605; H04L 2209/56; H04L 9/0637; G06Q 20/12

(57) ABSTRACT

The present disclosure relates to a digital data management system implemented, at least in part, on a server, where the server includes: one or more processors; non-transitory computer-readable media storing instructions executable by the one or more processors to perform operations including: receives a request to sell a digital asset; generating one or more sale offer terms associated with the request to sell the digital asset; receiving an offer to purchase the digital asset from a prospective buyer; verifying that the offer to purchase the digital asset conforms to the one or more sale offer terms; facilitating the purchase of the digital asset at least in part by executing a smart contract on a distributed ledger, the smart contract including at least one self-executing term; and storing information associated with the sale of the digital asset in the distributed ledger.

### CROSS REFERENCE TO RELATED APPLICATIONS

The present application claims the benefit under 35 U.S.C. § 119(e) of U.S. Provisional Application No. 62/723,754 filed Aug. 28, 2018, titled “Digital Asset Management,” the disclosure of which is incorporated herein by reference in its entirety. The present application also claims the benefit under 35 U.S.C. § 119(e) of U.S. Provisional Application No. 62/685,705 filed Jun. 15, 2018, titled “Digital Asset Management,” the disclosure of which is incorporated herein by reference in its entirety.

### BACKGROUND

Data stored in digital format may change ownership multiple times over the course of its lifetime. Individuals who sell or lease data stored in digital format may include authors or composers of books, music, and media. During the course of the data's lifetime, as the data changes ownership, the data or associated metadata may be altered without permission. This may occur despite efforts to secure a piece of digital data and associated metadata. For example, the piece of digital data may be stored on a central server and accessed through a centralized server system. However, the central server may still be hacked and in turn the piece of digital data and associated metadata may be altered. Accordingly, individuals wishing to exchange data stored in digital format but maintain the integrity of the data and associated metadata, face various challenges in the current systems.

### BRIEF DESCRIPTION OF THE DRAWINGS

For a detailed description of various embodiments, reference will now be made to the accompanying drawings in which:

FIG. 1 shows, in block diagram form, an example computer architecture in accordance with at least some embodiments.

FIG. 2 shows, in block diagram form, an example computer architecture in accordance with at least some embodiments.

FIG. 3 shows, in partial block diagram form, an example transaction protocol in accordance with at least some embodiments.

FIG. 4 shows an example timing diagram in accordance with at least some embodiments.

FIG. 5 shows an example method in accordance with at least some embodiments for facilitating, by a digital asset marketplace, a transaction between two entities.

FIG. 6 shows an example method in accordance with at least some embodiments for facilitating, by a digital asset marketplace, a transaction between two entities.

FIG. 7 shows an example method in accordance with at least some embodiments.

FIG. 8 shows an example method in accordance with at least some embodiments.

FIG. 9 shows, in block diagram form, an example system in accordance with at least some embodiments.

FIG. 10 shows an example method in accordance with at least some embodiments.

### DETAILED DESCRIPTION

Certain terms are used throughout the following description and claims to refer to particular system components. As one skilled in the art will appreciate, different companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The ability to track the origin (i.e., an ownership chain) of a piece of digital data may be beneficial in several areas. The added ability to trust that the information pertaining to the ownership chain is immutable is also beneficial to several areas. For example, a customer may be interested in verifying that jewelry adheres to fair trade standards. That is, a customer may be interested in verifying the source of the jewelry is truly following certain labor and environmental guidelines. In another instance, a doctor or a health patient may be interested in tracking the source digital data associated with tissue sample.

As yet another example, a buyer of a piece of digital media (i.e., music, book, movie, etc. in a digital format) may be interested in verifying that they are buying a copy of the digital media that is authorized by a publisher or author. Alternatively, an author or publisher may be more inclined to offer for licensing or purchase, a piece of digital media on a marketplace platform, if the author or publisher trusts that the piece of digital media will not be illegally copied or pirated once the piece of digital media is released on the marketplace platform.

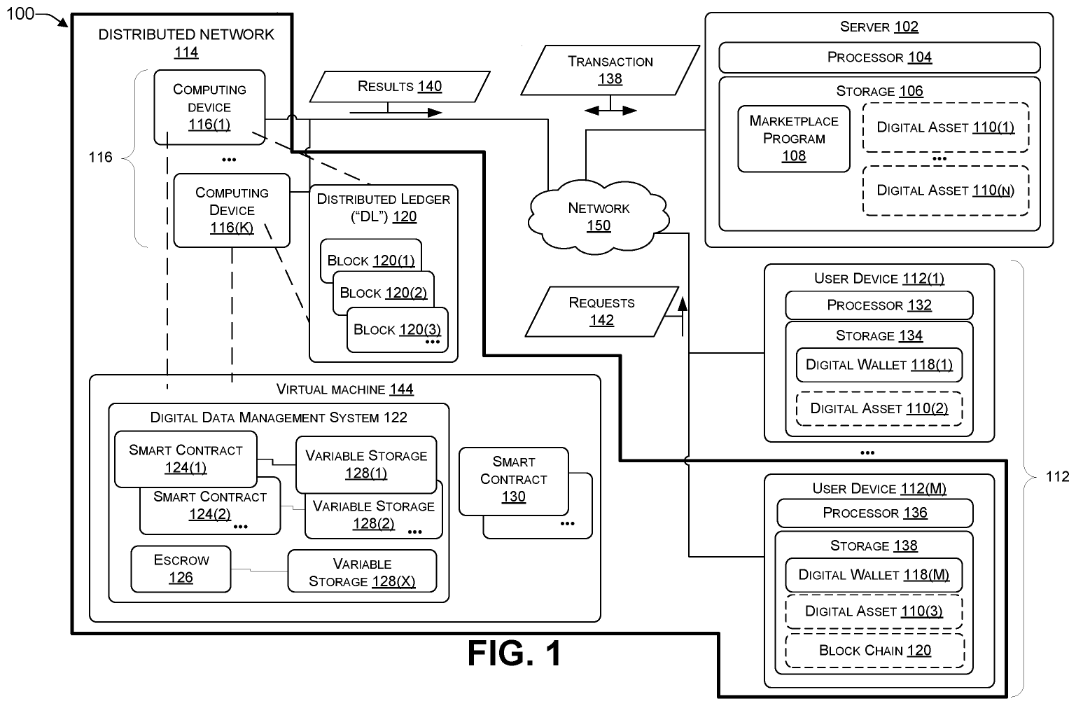

FIG. 1 illustrates a computer architecture 100 in which a digital data management system is implemented in a distributed network. The digital data management system provides a system that is able to track information pertaining to an ownership chain of a particular piece of digital data, where the ownership chain is immutable. In particular, FIG. 1 shows a server 102 communicatively coupled to a network such as network 150. Also communicatively coupled to the network 150 are user devices 112(1), . . . , 112(M) (collectively referred to as user devices 112), and computing devices 116(1), . . . , 116(K) (collectively referred to as computing devices 116), where the computing devices 116 are part of a distributed network 114.

Network 150 may include local area networks (LAN) and wide area networks (WAN). The network 150 may include wired technologies (e.g., Ethernet®) and wireless technologies (e.g., WiFi®, code division multiple access (CDMA), global system for mobile (GSM), universal mobile telephone service (UMTS), Bluetooth®, ZigBee®, etc.). For example, user device 112(1) may use a wireless technology (e.g., WiFi®, CDMA, GSM, etc.) to connect to server 102 over network 150, while server 102 may use a wired connection to connect to a computing device 116(1).

User devices 112 may include any device with which a user browses for digital assets over the network 150, such as a desktop computer, a laptop computer, smart phone, a tablet, a smart watch, and other various mobile devices. The user devices 112 may access the server 102 to browse for digital assets in a marketplace program. Individual ones of the user devices 112 may communicatively couple to network 150 through various local and/or wide area networks, including a portion being a wireless network.

Individual ones of the user devices 112 include at least one processing element (e.g., a central processing unit (CPU), a graphics processing unit (GPU), etc.) and storage including volatile and non-volatile forms of memory. For example, memory in individual ones of the user devices 112 may include random-access memory (RAM) and read-only memory (ROM). For example, user device 112(1) includes processor 132 and storage 134. User device 112(M) includes processor 136 and storage 138.

Individual ones of user devices 112 may have software (i.e., applications), operating systems, and data stored in their respective storage. For example, user device 112(1) may have a version of the application digital wallet 118(1) in storage 134. Additionally, user device 112(1) may have a digital asset 110(2) stored in storage 134. Similarly, user device 112(M) may have a version of the application digital wallet 118(M) and digital asset 110(3) in storage 138.

Individual ones of the application digital wallet 118(1), . . . , 118(M) may interface with marketplace program 108 or with individual ones of the computing devices 116 in the distributed network. In various embodiments, individual ones of the digital wallets 118(1), . . . , 118(M) may provide a user interface that provides a display of digital assets that may be available for lease or purchase through marketplace program 108. Additionally, individual ones of the digital wallets 118(1), . . . , 118(M) may be associated with an account. In one example, an account associated with digital wallet 118(1) may include a private key, a public key, and an address that is associated with the account in digital wallet 118(1). In yet another example, the address may be derived from the public key.

Server 102 may be one or more computing devices operated by a provider of a digital data marketplace. Server 102 may represent a group of networked elements that provides a service (e.g., networked elements arranged in a cloud, cloud computing). Server 102 may be owned or legally controlled by a legal entity managing and operating the digital data management system 112 and marketplace program 108. A provider of a digital data marketplace may provide a service through which buyers and sellers can track a chain of ownership of a piece of digital data. In the digital data marketplace, a chain of ownership is stored in such a manner that making changes to the majority of the copies of the chain of ownership is extremely difficult. Thus, a user of the marketplace may be more inclined to trust that piece of digital data on the marketplace is from a trustworthy source, as the chain of ownership is immutable. Additionally, creators of original pieces of work or product may be more inclined to sell or lease their works through the marketplace as it is nearly impossible to sell counterfeit or stolen pieces of work through the marketplace.

Server 102 includes one or more processors 104 (e.g., CPU, GPU, etc.) and storage 106. Server 102 may be illustrative of, for example, a node of several computers, a desktop computer, or any other computing system that may utilize memory in accordance with embodiments described herein. Storage 106 may store instructions that can be executed by the one or more processors 104. For example, storage 106 stores a marketplace program 108, and one or more digital assets 110(1), . . . , 110(N). One or more digital assets 110(1), . . . 110(N) may include any form of digital data that may be owned by a user of the marketplace program 108.

The digital data may represent the asset itself that is being sold or lease, or the digital data may represent or be associated with a physical asset that is being sold or leased. For example, one or more digital assets 110(1), . . . , 110(N) may include digital media such as digital music, digital books, digital movies, etc. The digital music, books, and movies are examples where the digital asset is digital data that is the asset itself that is being sold or leased.

In other examples, one or more digital assets 110(1), . . . 110(N) may include digital data that is associated with medical tests or a piece of jewelry. In examples where the digital assets are associated with healthcare, the medical tests may reflect results from clinical trials (i.e., trials benefiting or associated with pharmaceutical companies), or may reflect results associated with patients. The medical tests may reflect results of a blood draw or a urine sample, for example. Digital data associated with a piece of jewelry may include data tracking the origin of the piece of jewelry. The digital data associated with medical tests or a piece of jewelry are examples of digital data that represents or is associated with a physical asset that is being sold. (e.g., associated with a human body, associated with jewelry).

Marketplace program 108 may coordinate requests to buy or sell one or more digital assets 110(1), . . . , 110(N) and may interface with one or more user devices 112(1), . . . , 112(M) and a distributed network 114. More specifically marketplace program 108 may interface with associated applications on individual user devices, such as digital wallet 118(1) on user device 112(1) and digital wallet 118(M) on user device 112(M).

Distributed network 114 may include computing nodes that collectively adhere to a protocol for internode communication and managing a distributed ledger such as a block chain. A computing node in distributed network 134 may include any computing device such as computing device 116 or a user device 112(M). A computing node may also include data centers. As used herein, a computing node may refer to any computing device or multiple computing device (i.e., a data center) that stores a copy of distributed ledger 120 and adheres to the protocol for internode communication and managing distributed ledger 120.

As illustrated in FIG. 1, distributed network 114 includes one or more computing devices 116 and user device 112(M), where individual ones of the computing devices 116 and user device 112(M) may be referred to as a computing node within distributed network 114. Individual ones of the computing nodes (e.g., computing devices 116 and user device 112(M) in the distributed network 114 includes at least one processing element (e.g., a central processing unit (CPU), a graphics processing unit (GPU), etc.) and memory including volatile and non-volatile forms of memory. For example, memory in individual ones of the computing devices 116, and user device 112(M) may include random-access memory (RAM) and read-only memory (ROM).

The computing devices 116, and user device 112(M) in the distributed network 114 may include desktop computers, laptops, tablets, smartphones, and the like. The distributed network 114 may represent a distributed ledger-based distributed computing platform and operating system that features smart contract functionality.

A smart contract, according to various embodiments, may include a contract that is at least partially electronically self-executing Smart contract terms may be stored on a distributed ledger or blockchain for one or more contract execution programs to access. In some embodiments, one or more algorithms or executable code related to a smart contract may be stored on a digital ledger or block chain itself. As one example, a marketplace program such as marketplace 108 may access smart contract terms stored on a distributed ledger Marketplace program 108 may then further monitor for the existence of conditions precedent for execution of the contract. According to some example embodiments, market place program 108 may, upon receiving confirmation of payment associated with the purchase of a digital asset, enable electronic access to the purchaser of the digital asset and record relevant ownership chain information of the digital asset in a distributed ledger.

In various embodiments, a distributed ledger-based distributed computing platform may include a platform that utilizes a continuously growing list of records and executable code that form distributed ledger 120. Further, the continuously growing list of records and executable code may be divided into sections called blocks (e.g., block 120(1), block 120(2), block 120(3), . . . , etc.), where individual blocks are linked to each other and collectively, all the blocks linked to each other at any particular moment in time are collectively referred to as distributed ledger 120.

Each of the blocks in distributed ledger 120 may include a cryptographic hash of the previous block, a timestamp, and block data (e.g., transactions and executable code). Individual blocks such as block 120(1) may be secured using techniques for secure communication, such as cryptography. In FIG. 1, the number of blocks in distributed ledger 120 will continue to grow so long as the distributed network 114 is maintained and running. Accordingly, the blocks 120(1), 120(2), and 120(3) are representative of a portion of the distributed ledger 120 at a particular time, where at a time after the particular time, additional blocks may be added.

A copy of distributed ledger 120 resides within individual computing devices 116 and user device 112(M) that collectively form distributed network 114. Further, although distributed ledger 120 is illustrated in a separate box, the separate box is representative of what may be present on individual ones of the computing devices 116 and user device 112(M). That is, the box in FIG. 1 representing distributed ledger 120 does not represent a computing device that distributed ledger 120 is stored on, rather the box is representative of individual copies of distributed ledger 120 present on individual instances of the computing devices 116, and user device 112(M). Thus, existing copies of distributed ledger 120 may be found on the individual instances of the computing devices 116 and user device 112(M) in the distributed network 114.

Further, various computing nodes within the distributed network 114 may participate in different capacities. Individual instances of the computing devices 116 and user device 112(M) may store a copy of distributed ledger 120, while other computing devices both store a copy of distributed ledger 120 and perform mining tasks. For example, computing device 116(1), may store distributed ledger 120 and perform mining tasks related to maintaining distributed ledger 120, while user device 112(M) may store distributed ledger 120 without performing mining tasks.

In various embodiments, performing mining tasks may include a computationally intensive process that results in confirming transactions between parties, and creating a new block in the distributed ledger or block chain. For example, computing device 116(1) may perform mining tasks including: verifying if transactions are valid, and performing computationally intensive operations to add a new block to the distributed ledger.

More specifically, a new block is added to distributed ledger 120 after proof of work is completed, which includes a computationally intensive process for finding a particular hash signature of the new block. Accordingly, each block in distributed ledger 120 is signed with a unique hash signature. And each of the blocks in the distributed ledger are linked to a block immediately preceding a particular block by referencing the unique hash signature of the block immediately preceding the particular block.

For example, distributed ledger 120 may initially include block 120(1). In creating block 120(2), computing device 116(1) may create block 120(2) by placing the hash signature of block 120(1) in the header section of block 120(2), placing transaction data in the body of block 120(2), and perform proof of work to find a hash signature for block 120(2) that abides by a given set of predetermined parameters (e.g., the hash signature begins with a certain number of zeros).

A new block may be added by any one of the computing nodes within distributed network 114. When a new block is added by one of the computing nodes within distributed network 114, other computing nodes within distributed network 114 may also receive copies of the newly added block. For example, when computing device 116(1) adds block 120(2) to distributed ledger 120, individual computing devices in the distributed network 114 may also receive copies of block 120(2) that the individual computing devices add to local copies of distributed ledger 120 on the respective individual computing devices.

Once a new block is added (i.e., “recorded”), the data in preceding blocks cannot be altered retroactively without the alteration of all subsequent blocks, which requires collusion of the distributed network 114 majority (e.g., majority of the computing devices 116(1), . . . , 116(K)). Once block 120(2) is added to computing device 116(K) and user device 112(M), etc., the data in block 120(2) cannot be altered retroactively without the alteration of all subsequent blocks. For example, the header of block 120(2) contains the hash signature of block 120(1). If the data of block 120(1) were changed, the hash signature of block 120(1) would be different from the one stored in the header of block 120(2). The link between block 120(2) and block 120(2) would be broken. Thus, the data in block 120(1) cannot be changed retroactively without the alteration of all subsequent blocks including block 120(2), and 120(3) (and the blocks following block 120(3)).

The following example illustrates how difficult and nearly impossible it is to modify blocks in distributed ledger 120. Suppose computing device 116(1) attempts to change the data in block 120(1) stored locally on computing device 116(1). With respect to the distributed ledger 120 stored locally on computing device 116(1), the link between block 120(1) and 120(2) would be broken as the hash output of the altered block 120(1) would be different from the stored information in the header of block 120(2). Computing device 116(1) may fix the broken link by updating the header of block 120(2) to reflect the hash output of the altered block 120(1), and subsequently update the header information of all subsequent blocks in the locally stored distributed ledger 120 (e.g., block 120(3), etc.).

However, recall that copies of distributed ledger 120 are stored on multiple computing nodes throughout distributed network 114. Given the manner in which the individual computing nodes collectively adhere to a protocol for internode communication and managing distributed ledger 120, the version of distributed ledger 120 present on computing device 116(1) will be rejected by the distributed network 114, because the version of distributed ledger 120 on computing device 116(1) is not what a collective majority of the computing nodes in the distributed network 114 have stored in its respective storage. Thus, given the manner in which distributed ledger 120 is implemented using multiple computing nodes, distributed ledger 120 is incredibly resistant to modification of the data included in distributed ledger 120.

Recall that distributed ledger 120 may include block data that may further include executable code. In various embodiments, the executable code may enable smart contract functionality within distributed network 114. Smart contract functionality may include a computer protocol intended to facilitate a transaction between two or more parties. The smart contract may play a role in digitally facilitating negotiations, verifying that individual parties to the smart contract fulfill respective ends of their contract, and enforcing performance of the contract.

The distributed network 114 may carry out the smart contract functionality by way of virtual machine 144. Various smart contracts, such as smart contract 124(1), 124(2), and 130 may be implemented on virtual machine 144. In some embodiments, a digital data management system 122 may be implemented partially on virtual machine 144 by way of one or more smart contracts such as smart contract 124(1).

During execution, individual ones of the smart contracts 124(1), 124(2), and 130 may maintain state in its own permanent storage. That is, executable code associated with individual ones of the smart contracts are included in distributed ledger 120. As the executable code is stored in the distributed ledger 120, the executable code that creates the smart contract is immutable. However, during execution of the code associated with individual ones of the smart contract, a respective smart contract may change state when a variable is altered. The state or value of the variable may be stored in a respective storage location. For example, smart contract 124(1) may store variables in variable storage 128(1). Smart contract 124(2) may store variable in variable storage 128(2).

Smart contracts 124(1) and 124(2) are merely representative of one or more smart contracts that may be executed on virtual machine 144 as part of the digital data management system 122. Further, smart contracts are part of distributed ledger 120. Multiple smart contracts may be executed as part of the digital data management system 122, not limited to smart contracts 124(1) and 124(2). Accordingly, the ellipses after smart contract 124(2) are representative of the multiple smart contracts that may be executed on behalf of the digital data management system 122. Similarly, individual ones of the multiple smart contracts may have a respective variable storage. Accordingly, the ellipses after variable storage 128(2) are representative of the multiple variable storages that may be associated with respective ones of the multiple smart contracts.

Smart contracts executed as part of the digital data management system 122 may include information such as the terms under which an owner of a digital asset would like to sell or lease the digital asset. In some embodiments, the original owner such as the creator of digital asset may set the terms under which the digital asset may be sold or leased. Further, the smart contracts (e.g., smart contracts 124(1) and 124(2)) may track variables such as addresses of respective parties to a contract, proof of ownership, and proof of purchase. The information such as addresses of respective parties to a contract may be referred to as a mapping variable, while proof of ownership and proof of purchase may be referred to as a private variable. Both mapping and private variables may be stored in a respective variable storage associated with a smart contract.

In some embodiments, one or more additional smart contracts may be implemented as part of the digital data management system 122, as escrow 126. Executable code associated with escrow 126 may be added to the distributed ledger 120. During execution of a smart contract 124(1), 124(2), etc. in the digital data management system 122, escrow 126 may serve as a location at which a digital asset and funds are stored. In various embodiments, funds may represent one or more forms of agreed upon medium of exchange, such as currency. For example, funds may be an amount of dollars, Euro, ether, yen, bitcoins, etc.

Escrow 126 may release the digital asset and the funds to respective parties in a transaction after particular conditions are met. For example, escrow 126 may release the digital asset and funds after a predetermined time period. As another example, escrow 126 may release the digital asset and funds after receiving or confirming that individual parties to a particular smart contract have fulfilled their respective obligations under the smart contract.

Although escrow 126 has been illustrated as part of the digital data management system 122 within the distributed network 114, in some embodiments, the functionality of escrow 126 may be placed outside of the distributed network 114 and at a location such as server 102. For example, the executable code for escrow 126 may be stored in storage 106 and executed by processor 104 on server 102. Accordingly escrow 126 may be implemented in various ways including within distributed ledger 120 (e.g., deployed as a smart contract) or “off the block” at a location outside of distributed network 114.

The digital data management system 122 may also be partially implemented on server 102. As described previously, marketplace program 108 may coordinate requests to buy or sell one or more digital assets 110(1), . . . , 110(N). To coordinate a request to buy or sell one or more digital assets 110(1), . . . , 110(N), marketplace program 108 interacts with the distributed network 134.

An example is discussed to illustrate how a provider of a digital data marketplace may implement the digital data management system. In this example, a composer creates a song and saves it in digital format as digital asset 110(1). The composer may use user device 112(M) and digital wallet 118(M) to transmit a request (e.g., one or more requests 142) to the marketplace program 108 to present digital asset 110(1) to potential buyers. The composer may specify terms of the offer for sale, such as a number of copies she would like to sell and a purchase price for each copy that is sold Marketplace program 108 may store digital asset 110(1) as well as proof of ownership, in this case proof of origin or authorship in storage 106.

In some embodiments, marketplace program 108 may display the digital asset 110(1) to potential buyers browsing for digital assets in the marketplace program 108. The marketplace program 108 may indicate to potential buyers that digital asset 110(1) is available for purchase, as opposed to for lease. A potential buyer may use user device 112(1) to view the digital assets available for purchase or lease through the marketplace program 108. The potential buyer may request to buy digital asset 110(1) and transmit that request through network 150 (e.g., requests 142). In one example request, the buyer may indicate account information for purchasing digital asset 110(1) and the number of copies the buyer is requesting.

Upon receiving the buyer request, the marketplace program 108 may access the terms of the offer for sale associated with digital asset 110(1) and construct a smart contract 124(1) that reflects the terms of offer for sale. The marketplace program 108 may deploy smart contract 124(1) (e.g., transaction 138) to the distributed ledger 120 (i.e., deploy the smart contract 124(1) to the distributed network 114). Smart contract 124(1) may be implemented on virtual machine 144.

Smart contract 124(1) may store information such as an address of the buyer, an address of the seller, proof of ownership, and proof of purchase in variable storage 128(1). The address of the buyer and the address of the seller may include an address identifiable by the distributed network 114. Recall that a particular digital wallet may have an associated account, where the account includes a private key, a public key, and an address. The address of the buyer and the address of the seller may include addresses that are associated with respective digital wallets. For example, the address associated with digital wallet 118(M) may be the address of the seller. The address associated with the digital wallet 118(1) may be the address of the buyer.

In response to deploying smart contract 124(1), marketplace program 108 may transfer digital asset 110(1) to escrow 126. Additionally, marketplace program 108 may transfer an amount of funds to escrow 126 (an amount of funds provided by the buyer). Alternatively, the buyer, (by way of her digital wallet 118(1)) may transfer an amount of funds to escrow 126. Prior to the example transaction taking place, marketplace program 108 may have deployed a smart contract to the distributed ledger 120 to implement escrow 126.

In various embodiments, the digital asset 110(1) and the funds may remain in escrow 126 until smart contract 124(1) is able to verify that the terms defined in smart contract 124(1) have been fulfilled. For example, if the original composer indicated that she would like to sell ten copies of digital asset 110(1), the smart contract 124(1) may verify that no more than nine copies of digital asset 110(1) have been sold. Additionally, the smart contract 124 may verify that the buyer is purchasing a copy of the digital asset 110(1) for a purchase price at or above the purchase price specified by the composer.

In some examples, the marketplace program 108 may provide a sample of the digital asset 110(1) that is a predetermined length of the song. The sample of the digital asset 110(1) may be provided to the user device 112(1) for a predetermined amount of time to provide a user of the user device 112(1) the opportunity to confirm that digital asset 110(1) is the correct digital asset. In some examples, marketplace program 108 may provide a temporary link, set to expire after a predetermined amount of time, to the user device 112(1), where the temporary link provides user device 112(1) access to the sample.

While digital asset 110(1) and funds are placed in escrow 126, the smart contract 124(1) or marketplace program 108 may record the transaction taking place in distributed ledger 120. For example, the smart contract 124(1) or marketplace program 108 may record that digital asset 110(1) was sold by a user associated with digital wallet 118(M) and bought by a user associated with digital wallet 118(1). Once this transaction is recorded in distributed ledger 120, the transaction data is immutable and traceable. In this manner, the ownership chain for digital asset 110(1) is recorded into distributed ledger 120.

Escrow 126 may make a determination to release both digital asset 110(1) and funds to the buyer and seller respectively based on one or more several factors. For example, escrow 126 may release the digital asset 110(1) to user device 112(1) based on, a determination that a predetermined amount of time has passed since digital asset 110(1) was placed in escrow 126. Escrow 126 may release the digital asset 110(1) in response to receiving a confirmation that all terms of the smart contract 124(1) have been fulfilled. In some embodiments, escrow 126 may release the digital asset 110(1) after confirming that the transaction has been recorded in distributed ledger 120.

In some embodiments, the marketplace program 108 may confirm that the requested transaction between the buyer and seller has been completed (e.g., results 140), and in response, the marketplace program 108 may send a notification to escrow 126 that the digital asset 110(1) and funds may be released to respective parties.

Following this transaction, the distributed ledger 120 reflects that the digital wallet 118(1) is now the owner of digital asset 110(1). The example discussed may extend to scenarios where a digital asset 110(1) is loaned, leased, or otherwise temporarily transferred to a user. In such a scenario, the copy of the digital asset that is provided may be one that expires after a predetermined amount of time or based on other factors that determine the duration of the loan or lease period.

Additionally, a provider of the digital data marketplace may support reselling digital assets. In some embodiments, marketplace program 108 may implement a bidding system that allows potential buyers to bid on a particular digital asset. In one example, the bidding system may help regulate price points. Continuing the previous example, after purchasing digital asset 110(1), the user of user device 112(1) may decide to offer the digital asset 110(1) for purchase (i.e., resell the item). The user may use user device 112(1) and digital wallet 118(1) to transmit a request (e.g., one or more requests 142) to the marketplace program 108 to present digital asset 110(1) to potential buyers.

In response to receiving one or more requests 142, the marketplace program 108 may reference previously deployed smart contract 124(1) to determine the terms of offer for sale as originally specified by the composer of digital asset 110(1). For example, the composer may have specified the maximum number of times that digital asset 110(1) is allowed to be resold, or the composer may have specified the number of copies that may be sold of digital asset 110(1).

The marketplace program 108 or the digital data management system 112 may review the data stored in distributed ledger 120 to determine a number times a digital asset 110(1) has been resold, or the number of copies sold Smart contract 124(1) may validate that a transaction request may proceed. The data travelling back and forth between server 102 and the distributed network 114, regarding a specific transaction request is denoted as transaction 138.

In response to confirming that the particular transaction may proceed (i.e., digital wallet 118(1) is authorized to resell digital asset 110(1)), the marketplace program 106 may display or otherwise indicate to potential buyers that digital asset 110(1) is available for purchase. Upon receiving a buyer request (e.g., user device requests to purchase digital asset 110(1)), the marketplace program 108 may deploy smart contract 124(2) (e.g., transaction 138) to the distributed ledger 120 (i.e., deploy the smart contract 124(2) to the distributed network 114). Smart contract 124(2) may be implemented on virtual machine 144. In other embodiments, marketplace program 108 may utilize smart contract 124(1) to complete the transaction, where variable storage 128(1) is updated with an address of the buyer, an address of the seller (e.g., digital wallet 118(1)), proof of ownership, and proof of purchase.

Smart contract 124(2) may store information such as an address of the buyer, an address of the seller, proof of ownership, and proof of purchase in variable storage 128(2). Further, in response to deploying smart contract 124(2), marketplace program 108 may transfer digital asset 110(1) to escrow 126. Additionally, marketplace program 108 may transfer an amount of funds to escrow 126 (an amount of funds provided by the buyer). Alternatively, the buyer, (by way of his digital wallet), may transfer an amount of funds to escrow 126. The digital asset 110(1) and the funds remain in escrow until the terms of smart contract 124(2) are fulfilled.

Accordingly, a digital data management system may be implemented in a distributed network that manages a distributed ledger and includes smart contract capabilities. The digital data management system may provide a method for exchanging digital assets in a secure manner, where the source and history of ownership of a particular digital asset is traceable. The distributed ledger is used to store the chain of ownership for a particular digital asset, and as the data in the distributed ledger is immutable, the chain of ownership is trustworthy.

Given the manner in which the digital data management system is implemented, a user of the marketplace may be more inclined to trust that piece of digital data on the marketplace is from a trustworthy source, as the chain of ownership is immutable. Additionally, creators of original pieces of work or product may be more inclined to sell or lease their works through the marketplace as it is nearly impossible to sell counterfeit or stolen pieces of work through the marketplace.

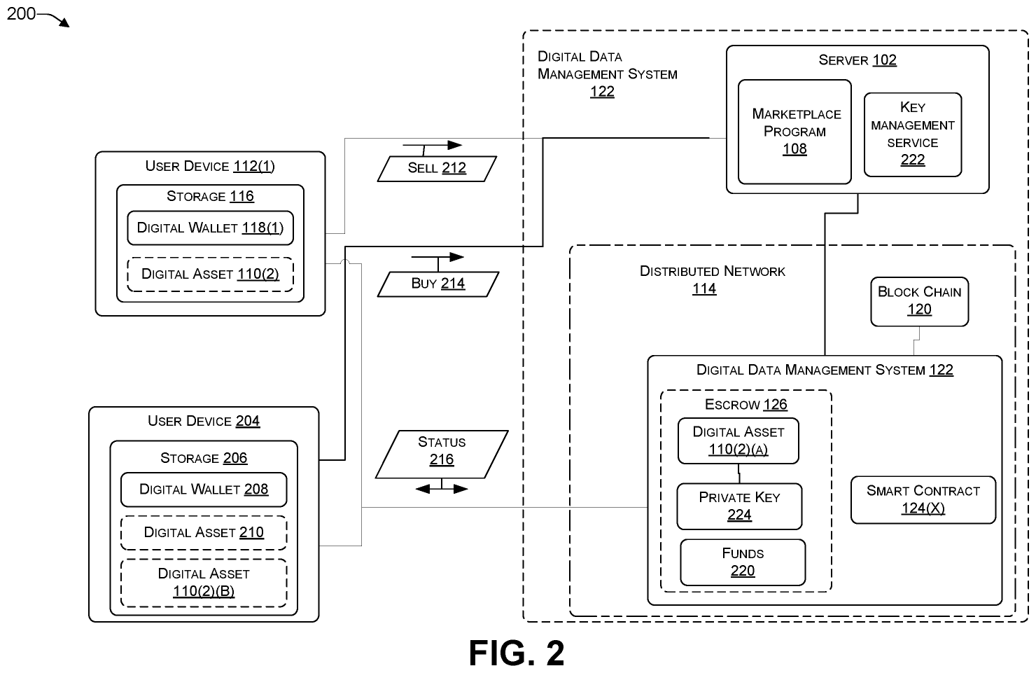

Turning now to FIG. 2, architecture 200 illustrates user devices using a digital data management system to buy, sell, or lease digital assets. In architecture 200, user device 112(1), server 102, and distributed network 114 as discussed in FIG. 1 are shown. The distributed network 114 includes one or more computing devices or computing nodes that collectively adhere to a protocol for internode communication and managing distributed ledger 120. In FIG. 2, digital data management system 122 is implemented on server 102 and distributed network 114. As discussed in FIG. 1, the digital data management system 122 may be partially implemented on distributed network 114 and partially implemented on server 102.

User devices 112(1) and 204 may use digital data marketplace 202 to buy, sell, or lease digital assets. In the example shown in FIG. 2, user device 112(1) may send a request to sell digital asset 110(12), by way of sell 212. In various embodiments, the digital asset 110(2) may be an original piece of work, or product, where a user of the user device 112(1) is the author or producer of digital asset 110(2). In other embodiments, the digital asset 110(2) may have been previously purchased by the user by way of digital wallet 118(1), and the request to sell may be a request to resell digital asset 110(2). In other embodiments, sell 212 may represent a request to lease digital asset 110(2) to an interested lessee.

Within the digital data management system 122, digital assets that are bought, sold, and leased are secured. When a user device, and more particularly the digital wallet on the user device transmits a request to sell or lease a digital asset, the digital asset may be locked or secured and transmitted to the digital data management system. Additionally, the request to sell or lease a digital asset may also transmit keys associated with a secured digital asset.

For example, request to sell 212, may include a request to sell digital asset 110(2), an identifier of digital wallet 118(1) (e.g., an address of digital wallet 118(1)), the secured digital asset 110(2), and a key to open secured digital asset 110(2). Additionally, in some embodiments, the request to sell 212, may include terms under which an owner would like to sell digital asset 110(2).

In response to receiving the request to sell 212, digital data management system 122 may store the digital asset 110(2) and associated keys or user account information (e.g., identifier of digital wallet 118(1)) on server 102 or at a location that is accessible by marketplace program 108, such as key management service 222. In various embodiments, key management service 222 may include a program that manages aspects of security that are associated with various user accounts, such as digital wallets 118(1) and 208, as well as security associated with digitals assets, such as digital asset 110(2), and 210. Key management service 222 may also include a database, where data, such as keys, encrypted keys, and secured digital assets, may be stored. Marketplace program 108 may access key management service 222 during any transactions described herein.

The marketplace program 108 may present digital asset 110(2) to potential buyers browsing to purchase or lease digital assets. A user of user device 204 may decide to buy digital asset 110(2). As illustrated in FIG. 2, user device 204, and more specifically digital wallet 208 may transmit a request to buy 214 to marketplace program 108.

In various embodiments, request to buy 214 may include a request identifying the digital asset 110(2) and an indication that a user would like to purchase the digital asset, an identifier of the digital wallet 208 (e.g., an address of digital wallet 208), and a source of funds to purchase digital asset 110(2). In response to receiving the request to buy 214, the marketplace program 108 may deploy a smart contract (e.g., smart contract 124(X)) to distributed network 114, to facilitate the exchange between buyer and seller in a manner described in FIG. 1.

In particular, when marketplace program 108 transmits digital asset 110(2) to escrow 126, marketplace program 108 may access key management service 222 to retrieve one or more of the following: the digital asset (secured or locked), a private key (associated with buyer's digital wallet), and an encrypted key. In one example, the marketplace program 108 may receive a public key and address. Thus, during the example transaction, in response to receiving the request to buy 214, the marketplace program 108 may transmit the digital asset 110(2) to escrow (shown as digital asset 110(2)(a)) in an encrypted format that is also digitally signed in a secure manner using a seller's private key (e.g., private key 224).

In various embodiments, the marketplace program 108 and the key management service 222 are independently operating pieces of software. That is, the key management service 222 may provide services to several applications including distributed applications that include the marketplace program 108 and other distributed ledgers.

A user device 204 may transfer funds 220 to escrow 126 after transmitting request to buy 214. For example, user device 204 may use digital wallet 208 to transfer funds to escrow 126. In the event that both parties fulfill respective obligations, escrow 126 releases digital asset 110(2) (A) to digital wallet 208 (e.g., digital asset 110(2) (B)), and funds 220 to digital wallet 118(1).

In various embodiments, user devices 112(1) and 204 are not restricted to accessing the distributed network 114 through marketplace program 108. For example, during the example transaction including the requests to sell 212 and buy 214, user devices 112(1) and 204 may directly communicate with the distributed network 114 (e.g., status 216), to check on a status of a transaction. For example, user device 112(1) may check the distributed ledger 120 to determine whether the transfer has been recorded in the distributed ledger 120. Thus, individual ones of the user devices may access the distributed network for various tasks, such as to check on a status of the transaction.

In other embodiments, the functionality provided by the marketplace program 108 may be implemented on individual ones of the digital wallets on respective user devices.

Accordingly, a digital data management system may be implemented in a distributed network that manages a distributed ledger, such as a block chain, and includes smart contract capabilities. The digital data management system may provide a method for exchanging digital assets in a secure manner, where the source and history of ownership of a particular digital asset is traceable. The distributed ledger is used to store the chain of ownership for a particular digital asset, and as the data in the block chain or distributed ledger is immutable, the chain of ownership is trustworthy.

Given the manner in which the digital data management system is implemented, a user of the marketplace may be more inclined to trust that piece of digital data on the marketplace is from a trustworthy source, as the chain of ownership is immutable. Additionally, creators of original pieces of work or product may be more inclined to sell or lease their works through the marketplace as it is nearly impossible to sell counterfeit or stolen pieces of work through the marketplace.

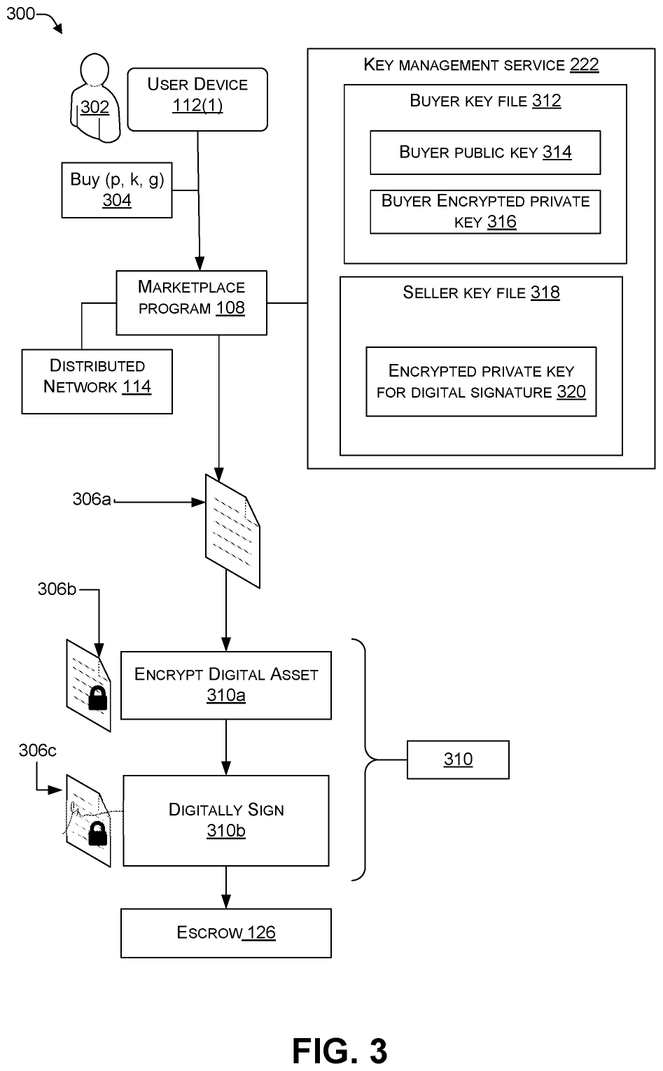

FIG. 3 illustrates aspects of transferring a digital asset from one user to another in a secure manner within the digital data management system. More specifically, a transaction protocol is shown. Initially, a user 302 may send a request to buy 304, byway of user device 112(1). The buy request 304 may include data such as a public key that is associated with a buyer account (e.g., digital wallet 118 in FIG. 1) as well as the requested digital asset (e.g., digital asset 306a). In one example, the buy request 304 may pass elliptic curve parameters. For example, the buy request 304 may pass elliptic curve parameters as part of the public key. The public key of the buyer 302 may be stored as buyer public key 314 within key management service 222. In particular, the buyer public key 314 may be stored within a buyer key file 312 that is associated with a buyer account and more particularly with a digital wallet of the buyer 302 (e.g., digital wallet 118 in FIG. 1). In some embodiments, the key management service 222, may manage a private key that is associated with a buyer account.

The buyer public key and private key may be used for encryption and decryption purposes. For example, the buyer public key may be used by a seller account to encrypt a digital asset, and the buyer private key may be used to decrypt the digital asset. The buyer public key 314 may be formed from a combination of one or more of the following associated with the buyer: a private key, an address, and a passphrase associated with a particular user account (e.g., digital wallet 118(1) in FIG. 1). Key management service 222 may store the buyer's private key in an encrypted format that may only be decrypted by an account of the buyer (e.g., digital wallet 118(1) in FIG. 1).

In response to receiving the request to buy 304, the marketplace program 108 may process the transaction and act as a proxy for the seller. The marketplace program 108 may retrieve the digital asset 306a and process the digital asset 306a with two layers of security 310 before placing the secured digital asset 306a into escrow 126. The two layers of security 310 allow for the digital asset 306a to remain secured despite undergoing multiple verification processes that may be performed by distributed network 114. For example, the two layers of security 310 may enable zero-knowledge proof, a method or process where one person (the prover) can prove something to another person (the verifier) that a given statement is true without revealing additional information about the statement apart from the fact that the statement is true. In other words, the contents of the digital asset 306a remain secured, so no one can copy to digital asset, but entities within the distributed network 114 may verify and confirm identifications of the parties involved in the transaction.

The first layer of security, encrypt digital asset 310a, includes encrypting the digital asset 306a. The marketplace program 108 may use a buyer public key 314 to encrypt (e.g., lock) the digital asset 306a to created encrypted digital asset 306b. Only the buyer's private key may be used to decrypt (e.g., unlock) the encrypted digital asset 306b. The second layer of security, digitally sign 310(b), includes digitally signing the encrypted digital asset 306b. The encrypted digital asset 306b is signed using a private key of the seller to create an encrypted and signed digital asset 306c. The private key used to sign the encrypted asset 306b is associated with a digital signature of the seller. More specifically, the private key used to digitally sign digital assets is separate from a private key of the seller that may be used to decrypt a digital asset.

The marketplace program 108 may access a seller's private key for digital signatures in key management service 222. In particular, the seller's private key for digital signatures may be stored in an encrypted format in the seller key file 318 (e.g., seller digital signature encrypted private key 320) Similar to the buyer key file 312, the seller key file 318 is associated with a seller account and more particularly with a digital wallet of the seller (e.g., digital wallet 118(M) in FIG. 1). The public key associated with the seller's digital signature is published so that other entities may confirm that the encrypted digital asset 306b does indeed originate from the seller.

Next the marketplace program 108 places the encrypted and signed digital asset 306c into escrow 126. In various embodiments, escrow 126 may perform various verification procedures to ensure the encrypted and signed digital asset 306c does indeed originate from a seller and owner of the digital asset 306a. After the encrypted and signed digital asset 306c is released to buyer 302, buyer 302 may use buyer public key (i.e., buyer public key 314) to decrypt the digital asset and view or consume the contents of the digital asset.

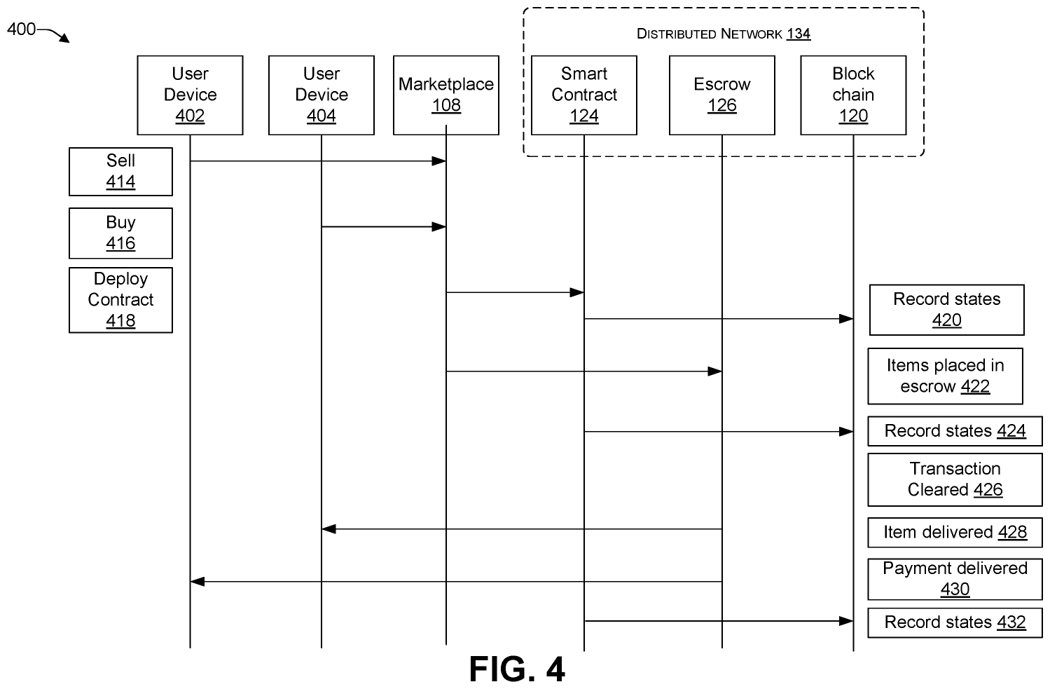

Turning now to FIG. 4, a sequence diagram 400 illustrates a method of selling a digital asset through a marketplace according to an embodiment. Additional methods and processes may be included within these methods and may be recognized by one or ordinary skill in the art, in light of the description below. Further, in some embodiments, the described methods may be combined, mixed, and matched, as one of ordinary skill would recognize.

In step 414, a user device 402 transmits a request to sell a digital asset to marketplace 406. For example, this may be one of requests 142 as discussed in FIG. 1 or sell 212 as discussed in FIG. 2. The marketplace 108 may access information internal to marketplace 108 to determine whether the digital asset is a digital asset being sold for the first time within marketplace 108 or whether it is a digital asset that is being resold (e.g., purchased previously through marketplace 108).

Messages between seller and buyer (with the marketplace 406 acting as a party in between seller and buyer), may contain information such as the digital asset license information. Messages may be encrypted using a public/private key asymmetric encryption based on various known methods such as elliptic curve integrated encryption scheme (“ECIES”).

For example, a message payload originating from the seller may be digitally signed and further encrypted by the seller using the buyer's public key. Once received, the buyer may be able to decrypt the message payload with his private key.

If the digital asset is being sold for the first time, marketplace 108 may query user device 402 for additional information such as information about the source of the digital asset and specifics regarding terms under which the digital asset may be sold (e.g., number of copies, that may be sold, the number of times a digital asset may be resold, etc.). If the digital asset is being resold, marketplace 108 may access information within distributed network 134 to determine whether the item may be resold and an amount at which the digital asset may be resold. The marketplace 108 displays the digital asset and indicates the digital asset is available for purchase to various users of marketplace 108.

At step 416, user device 404 transmits a request to buy the digital asset. This may be one or more requests 142 as discussed in FIG. 1 or buy 214 as discussed in FIG. 2. At step 418, marketplace 108 may deploy a smart contract to distributed network 134, where it is implemented as smart contract 124. At step 420, during the facilitation of the transaction, where user device 402 sells a digital asset to user device 404, smart contract 124 may record several states on distributed ledger 120.

At step 422, items including the digital asset and funds may be placed in escrow, such as escrow 126. The digital asset and funds may be transferred from a user device or the marketplace. For example, as discussed in FIG. 2, marketplace 108 may transfer the digital asset while a user device initiates a transfer of funds to the escrow account. At step 424, additional states may be recorded related to the transaction and escrow account. At step 426 a transaction is cleared. This may be a step at which the distributed ledger 120 records that user device 402 has sold a digital asset to user device 404 for an X amount of currency. Where X represents any number.

The escrow account (e.g., escrow 126) may check the distributed ledger 120 and in response to detecting that the transaction has been recorded in distributed ledger 120, at steps 428 and 430, escrow 126 releases the items in escrow to respective parties. For example, escrow may deliver the digital asset to user device 404 and escrow may deliver funds to user device 402. In another example, as discussed in FIG. 2, the escrow account may release the digital asset and funds after a predetermined time period. At step 432, smart contract 124 may record final states in distributed ledger 120 after the transaction is complete.

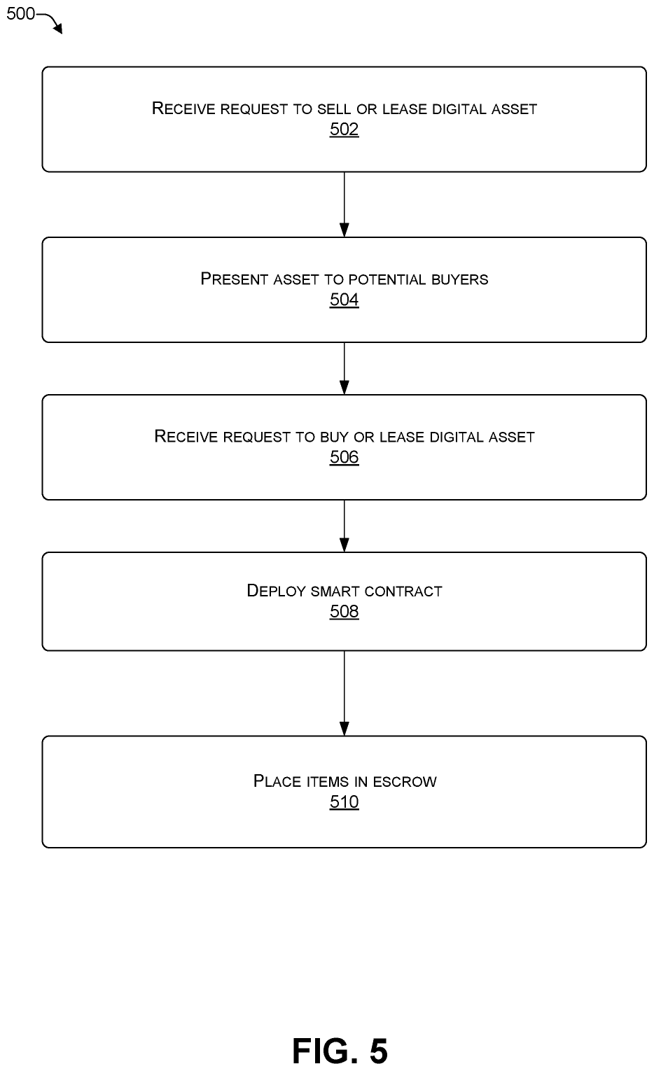

FIG. 5 shows an example method in accordance with at least some embodiments for partially facilitating, by a digital asset marketplace, a transaction between two entities, as discussed herein. The marketplace receives a request to sell or lease a digital asset and facilitates the transaction in a manner that maintains the integrity of the ownership chain of the digital asset. In various embodiments, some of the blocks shown in FIG. 5 may be performed concurrently, in a different order than shown, or omitted. Additional method elements may be performed as desired.

Initially, the digital data marketplace may receive a request to sell or lease a digital asset (block 502). As discussed previously, this request may come from an original owner, author, composer, etc. through his user device. The digital data marketplace may present the digital asset to potential buyers (block 504). The digital data marketplace may provide a graphical interface that displays digital assets available for purchase to individual buyers. The digital data marketplace may receive a request to buy the digital asset (block 506).

In response to receiving the request to buy the digital asset, the digital data marketplace may deploy a smart contract (block 508). As discussed in FIGS. 1 and 2, the digital data marketplace may deploy the smart contract to a distributed ledger or block chain implemented on a distributed network. The smart contract is implemented on a virtual machine within the distributed network. The digital data marketplace may place respective items in escrow (block 510). For example, the digital data marketplace may place the requested digital data asset into escrow. Subsequently, the remainder of the transaction may be coordinated and facilitated by executable code within smart contracts deployed within the distributed network.

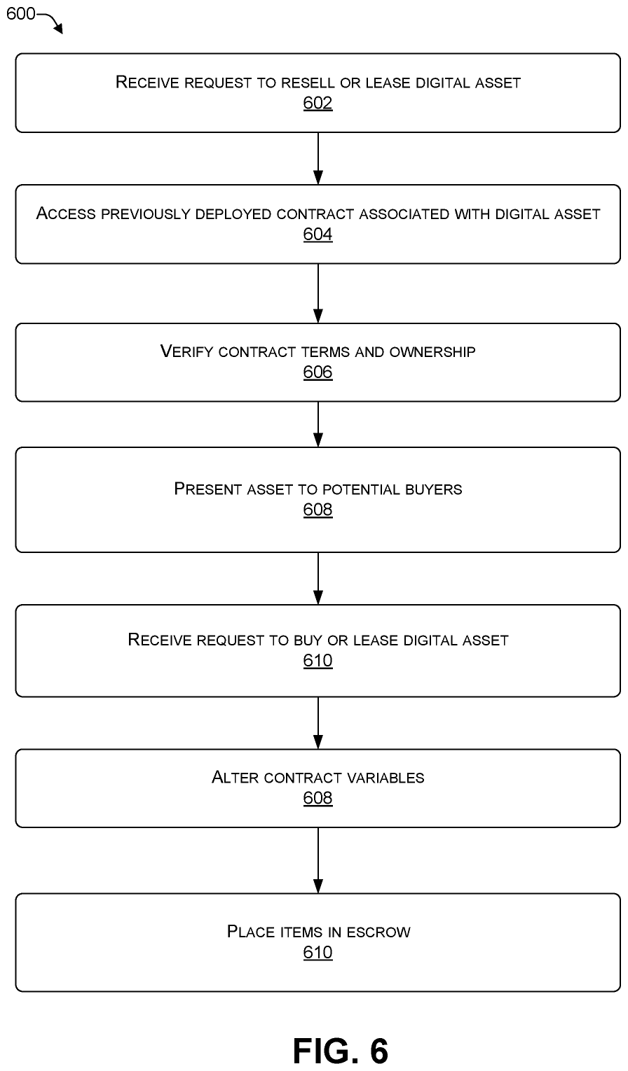

FIG. 6 shows an example method in accordance with at least some embodiments for partially facilitating, by a digital asset marketplace, a transaction between two entities, as discussed herein. The marketplace receives a request to sell or lease a digital asset and facilitates the transaction in a manner that maintains the integrity of the ownership chain of the digital asset. In various embodiments, some of the blocks shown in FIG. 6 may be performed concurrently, in a different order than shown, or omitted. Additional method elements may be performed as desired.

Initially, the digital data marketplace may receive a request to resell or lease a digital asset (block 602). In this example, the request to resell or lease the digital asset may be for a digital asset previously sold or leased. The request to resell or lease the digital asset may come from an owner or leasor, through his user device. The digital data marketplace may access a previously deployed contract associated with the digital asset (block 604). For example, the digital data marketplace may have deployed a smart contract associated with the digital asset in response to receiving the digital asset from an original owner, author, composer, etc. The deployed smart contract may define particular terms for selling or leasing the digital asset.

The digital data marketplace may verify contract terms and ownership (block 606). For example, if the previously deployed smart contract specified that a digital asset may be resold for a maximum of ten times, the digital data marketplace may reference the ownership chain recorded in the distributed ledger to determine the number of times the digital asset has been resold. If the digital asset has been resold less than ten times, the digital data marketplace may present the digital asset to potential buyers (block 608). The digital data marketplace may provide a graphical interface that displays digital assets available for purchase to individual buyers. The digital data marketplace may receive a request to buy or lease the digital asset (block 610).

In response to receiving the request to buy or lease the digital asset, the digital data marketplace may cause the smart contract associated with the digital asset to alter contract variables (block 608). The contract variables may be variables associated with the smart contract associated with the digital asset. For example, the variables may reflect the respective parties to the contract. The digital data marketplace may place respective items in escrow (block 610). For example, the digital data marketplace may place the requested digital data asset into escrow. Subsequently, the remainder of the transaction may be coordinated and facilitated by executable code within smart contracts deployed within the distributed network.

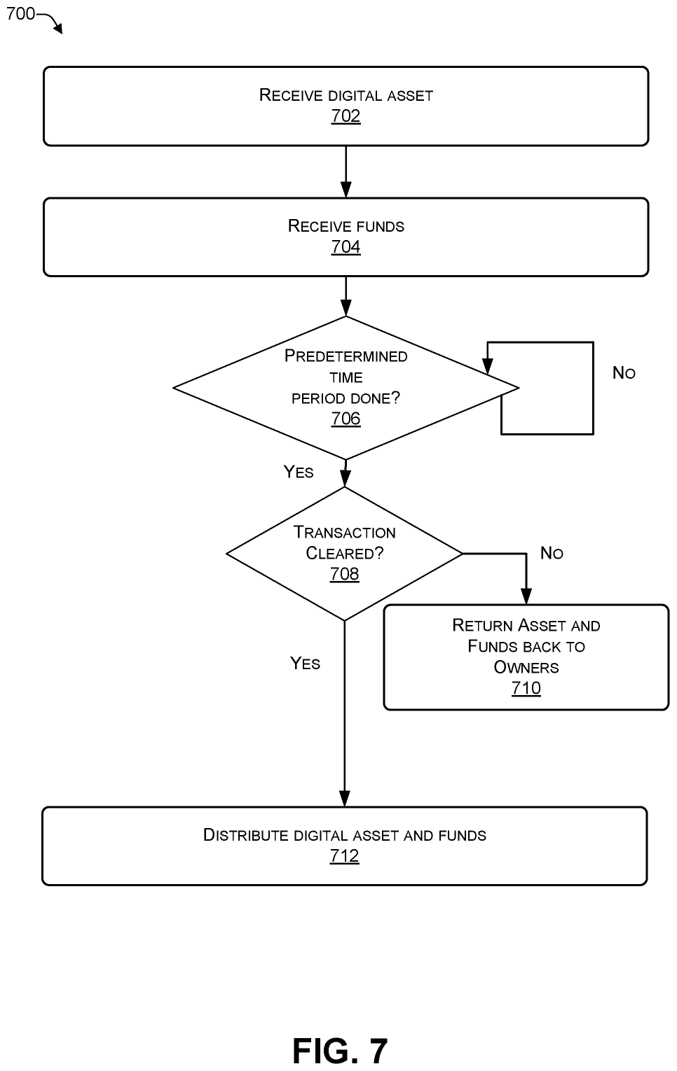

FIG. 7 shows an example method in accordance with at least some embodiments for partially facilitating, by a smart contract implementing an escrow account, a transaction between two entities. In various embodiments, some of the blocks shown in FIG. 7 may be performed concurrently, in a different order than shown, or omitted. Additional method elements may be performed as desired. In relation to a particular transaction, the escrow account may receive a digital asset (block 702). The digital asset may be transferred from the digital data marketplace or from a user device. The escrow account may also receive funds (block 704). The funds may be transferred from an account holding currency to the escrow account.

The escrow account may wait until a predetermined time period is done (block 706). If the predetermined time period is not done, then the flow remains at block 706. Once the predetermined time period is done, the escrow account may determine whether the transaction is cleared (block 708). For example, the change in ownership may be recorded in the distributed ledger and the escrow account may check the distributed ledger to determine whether the change in ownership has been recorded.

In another example, a buyer may receive a temporary link to sample the digital asset. During the predetermined time period, the buyer may decide based on the sample, or for other reasons that the buyer no longer wishes to purchase the item. During the predetermined time period, the buyer may indicate his intention to no longer purchase the item. Accordingly, a transaction may not clear as the buyer no longer wishes to purchase the item.

If the transaction has not cleared, the escrow account may return the asset and funds back to the seller and buyer respectively (block 710). If the transaction clears, the escrow account distributes the digital asset and funds (block 712).

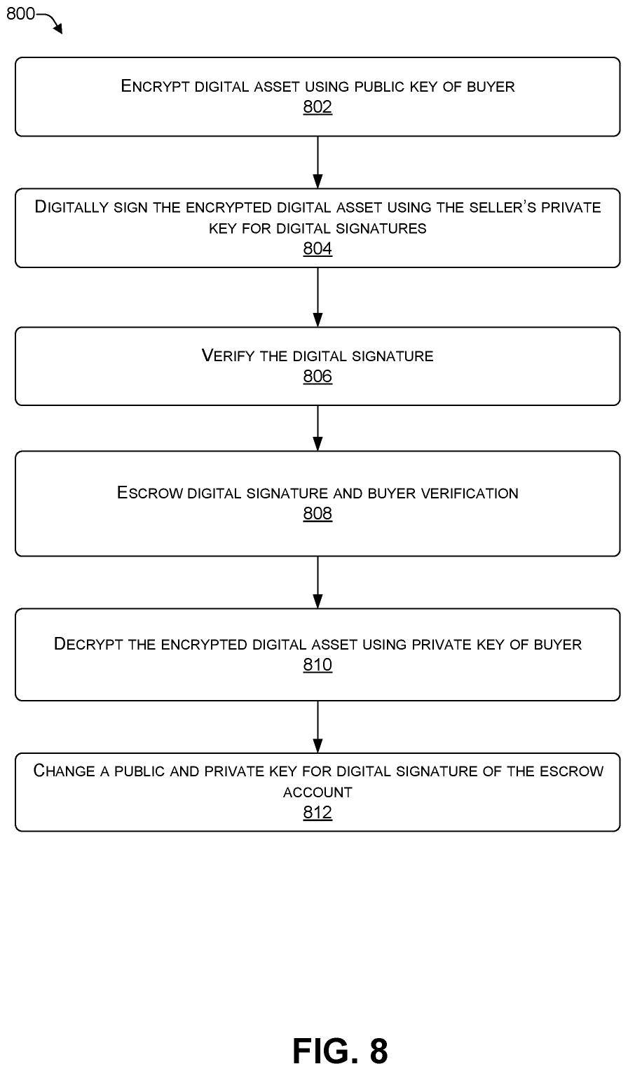

FIG. 8 shows an example method in accordance with at least some embodiments of a transaction protocol between at least two entities. In various embodiments, some of the block shown in FIG. 8 may be performed concurrently, in a different order than shown, or omitted. Additional method elements may be performed as desired. In relation to a particular transaction, once a marketplace program receives a buy request for a digital asset, the marketplace program may encrypt the digital asset using a public key of the buyer (block 802). In some examples, this step may be represented or referred to as a seller encrypts (e.g., using ECIES) the digital asset with a public key of the buyer. Next the marketplace program, acting as a proxy for the seller, may digitally sign the encrypted digital asset using the seller's private key for digital signatures block 804). This step may be represented or referred to as a seller digitally signs the digital asset with seller's private key.

Next, various entities within the distributed network 134 may perform various verification processes, such as verifying the digital signature (block 806). For example, this step may be represented or referred to as seller send the encrypted and signed digital asset to the buyer by way of the distributed ledger. Various distributed ledger transactions may validate whether the seller is the claimed seller. Additionally, various entities, including the escrow account may verify the digital signature and an identity of the buyer (block 808).

After the verification processes are complete, the encrypted and signed digital asset is released to the buyer. The encrypted and signed digital asset may be decrypted using a private key of the buyer (block 810). That is, the buyer may decrypt the digital asset using his private key. At predetermined time periods, the escrow account may change a public and private key for digital signature of the escrow account (block 812).

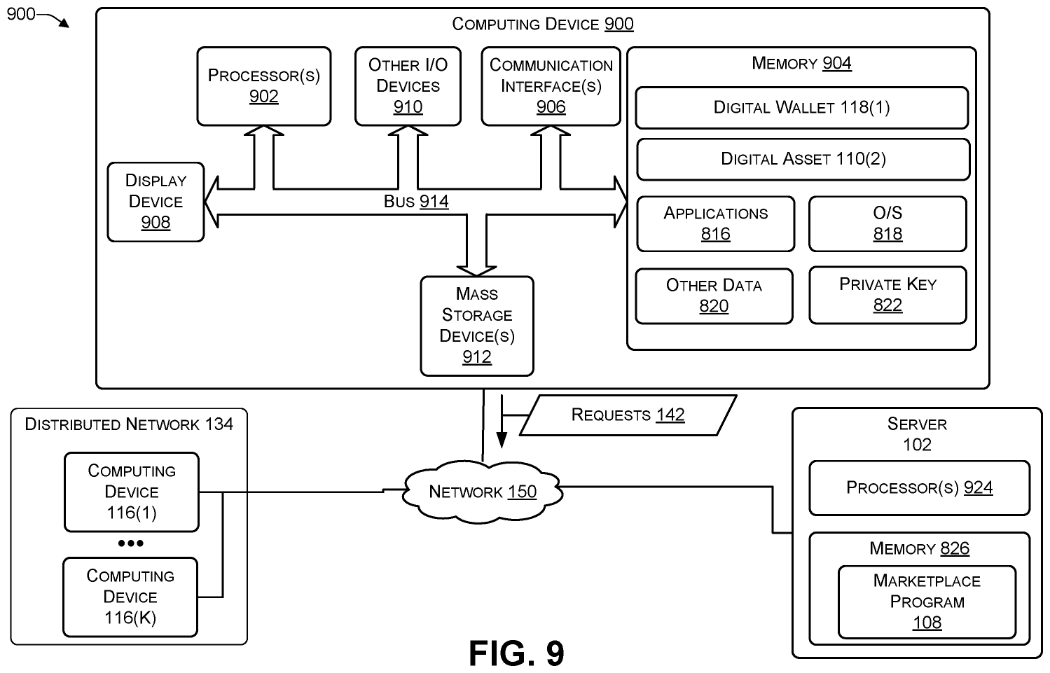

FIG. 9 illustrates an example configuration of a computing device 900 that can be used to implement the systems and techniques described herein, such as for example, the computing entities in computer architecture 100 of FIG. 1, such as computing devices 116(1), . . . , 116(K), virtual machine 144, server 102, and user devices 112(1), . . . , 112(M) of FIG. 1, user device 204 of FIG. 2, and user devices 402 and 404 of FIG. 4. The computing device 900 may include one or more processors 902 (e.g., CPU, GPU, or the like), a memory 904, communication interfaces 906, a display device 908, other input/output (I/O) devices 910 (e.g., keyboard, trackball, and the like), and one or more mass storage devices 912 (e.g., disk drive, solid state disk drive, or the like), configured to communicate with each other, such as via one or more system buses 914 or other suitable connections. While a single system bus 914 is illustrated for ease of understanding, it should be understood that the system buses 914 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 902 are one or more hardware devices that may include a single processing unit or a number of processing units, all of which may include single or multiple computing units or multiple cores. The processors 902 may include a graphics processing unit (GPU) that is integrated into the CPU or the GPU may be a separate processor device from the CPU. The processors 902 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 902 may be configured to fetch and execute computer-readable instructions stored in the memory 904, mass storage devices 912, or other computer-readable media.

Memory 904 and mass storage devices 912 are examples of computer storage media (e.g., memory storage devices) for storing instructions that can be executed by the processors 902 to perform the various functions described herein. For example, memory 804 may include both volatile memory and non-volatile memory (e.g., RAM, ROM, or the like) devices. Further, mass storage devices 912 may include hard disk drives, solid-state drives, removable media, including external and removable drives, memory cards, flash memory, floppy disks, optical disks (e.g., CD, DVD), a storage array, a network attached storage, a storage area network, or the like. Both memory 904 and mass storage devices 912 may be collectively referred to as memory or computer storage media herein and may be any type of non-transitory media capable of storing computer-readable, processor-executable program instructions as computer program code that can be executed by the processors 902 as a particular machine configured for carrying out the operations and functions described in the implementations herein.

The computing device 900 may include one or more communication interfaces 906 for exchanging data via the network 150. The communication interfaces 906 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 906 can also provide communication with external storage, such as a storage array, network attached storage, storage area network, cloud storage, or the like.

The display device 908 may be used for displaying content (e.g., information and images) to users. Other I/O devices 910 may be devices that receive various inputs from a user and provide various outputs to the user, and may include a keyboard, a touchpad, a mouse, a printer, audio input/output devices, and so forth.

The computer storage media, such as memory 904 and mass storage devices 912, may be used to store software and data. For example, where computing device 900 represents a user device (e.g., user device 112(1), . . . , 112(M), 204, 402, or 404), the computer storage media may be used to store storage digital wallet 118(1), one or more digital asset 110(2), applications 916, operating system (O/S) 918, other data 920, and private key 922.

The computing device 800 may be communicatively coupled via the network 150 to one or more computing devices 116(1), . . . , 116(K) and server 102. Similar to computing device 900, the one or more computing devices 116(1), . . . , 116(K), and server 102 may include respective processors and computer storage media. For example, server 102 may include processors 924 and memory 926. The one or more computing devices 116(1), . . . , 116K) may be part of distributed network 134 where computing nodes collectively adhere to a protocol for internode communication and managing a distributed ledger such as a block chain.

Server 102 may host a digital data management system such as marketplace program 108. The marketplace program 108 may receive requests 142 to sell or buy a digital asset. Marketplace program 108 may utilize distributed network 134 to facilitate the exchange of digital assets between user devices. As information in the distributed ledger is stored in a manner that requires more than fifty percent of the computing nodes agree on the stored information, a hacker would have difficulty altering information stored within distributed network 134.

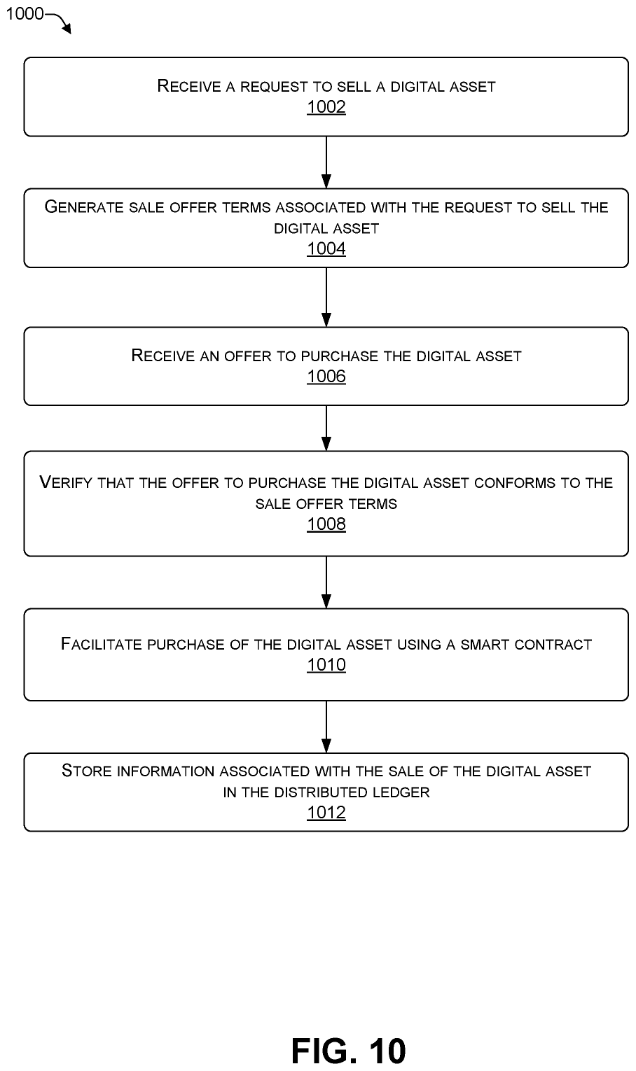

FIG. 10 shows an example method in accordance with at least some embodiments for at least partially facilitating the sale of a digital asset. In various embodiments, some of the blocks shown in FIG. 10 may be performed concurrently, in a different order than shown, or omitted. Additional method elements may be performed as desired.

In relation to a particular transaction, a system or module such as marketplace program 108 may receive a request to sell a digital asset (block 1002). According to some embodiments, the system may generate sale offer terms associated with the request to sell the digital asset (block 1004). Some or all of these terms may be received from a seller of the digital asset directly, for example as part of the request itself or by manual entry of offer terms. In some embodiments, some or all of the terms of the offer for sale of the digital asset may have been previously stored, for example in the case that an original owner of the digital asset has previously recorded and set restrictions on resale or number of copies available.

The system may receive an offer to purchase the digital asset (block 1006) from a prospective buyer. According to some embodiments, the offer may comport to the terms of sale published by the system, or may effectively propose different terms if one or more of the terms of the offer for sale do not comport with the sale offer terms.

The system may verify that the terms of the offer to purchase the digital asset conform to the sale offer terms (block 1008). According to some embodiments, the system may facilitate digital negotiation directly between the seller of the digital asset and the prospective buyer in order to resolve any variance between the terms of the offer for sale and the offer for purchase of the digital asset.

The system may facilitate purchase of the digital asset using a smart contract (block 1010) according to some or all of the embodiments and features discussed herein. As one, a partially self-executing smart contract may include holding the digital asset in escrow by blocking access to the digital asset by any party until payment for the purchase of the digital asset has been verified.

When the sale has been completed, information associated with the sale of the digital asset may be stored in the distributed ledger (block 1012). As one example, a chain of title related to the digital asset may be updated to reflect the purchaser as the new owner of the digital asset. It should be noted that several distributed computing systems or distributed ledgers may be employed. For example, a first distributed ledger may include information about restrictions on the sale of the digital asset, while a second distributed ledger holds information related to an escrow service and/or smart contract, and a third distributed ledger contains chain of title or ownership data related to the digital asset—or any such appropriate combination as would be apparent to a person having ordinary skill in the art.

Accordingly, when exchanged through the marketplace program 108, digital assets maintain integrity. Furthermore, a chain of ownership as digital assets are exchanged through the marketplace program may also be trusted, as the record of the chain of ownership is immutable.

In an alternative embodiment of the market place program 108, the digital assets can be represented by a cryptographic token. This cryptographic token is generated using cryptographic algorithms for example Secure Hash Algorithm (SHA) or lattice cryptographic algorithm etc. The cryptographic token may be referred to as a secure token and can be defined in such way that a particular cryptographic/secure token represents a digital asset and this representation is immutable. The immutability of the representation makes the cryptographic/secure token non-fungible as there cannot be an equivalent representation by another cryptographic/secure token.

References to “one embodiment”, “an embodiment”, “some embodiments”, “various embodiments”, or the like indicate that a particular element or characteristic is included in at least one embodiment of the invention. Although the phrases may appear in various places, the phrases do not necessarily refer to the same embodiment or example.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A digital data management system implemented, at least in part, on a server, the server comprising:
one or more processors;
non-transitory computer-readable media storing instructions executable by the one or more processors to perform operations comprising:
receiving a request to sell a digital asset;
generating one or more sale offer terms associated with the request to sell the digital asset;
receiving an offer to purchase the digital asset from a prospective buyer;
verifying that the offer to purchase the digital asset conforms to the one or more sale offer terms;
facilitating the purchase of the digital asset at least in part by executing a smart contract on a distributed ledger, the smart contract comprising at least one self-executing term; and
storing information associated with the sale of the digital asset in the distributed ledger.

2. The system of claim 1, wherein facilitating the purchase of the digital asset further comprises enabling the purchase of the digital asset through an escrow service

3. The system of claim 2, wherein enabling the purchase of the digital asset through an escrow service comprises:
locking electronic access to the digital asset;
receiving data indicating that at least one of the one or more sale offer terms has been satisfied; and
enabling electronic access to the digital asset to the purchaser of the digital asset.

4. The system of claim 3, wherein enabling the purchase of the digital asset through an escrow service further comprises:
receiving a payment for the purchase of the digital asset;
holding the payment for the purchase of the digital asset in the escrow service at least until receiving data indicating that the at least one of the one or more sale offer terms has been satisfied; and
releasing the payment to a seller of the digital asset.

5. The system of claim 1, wherein storing information associated with the sale of the digital asset comprises storing, in the distributed ledger, information related to a chain of ownership of the digital asset.

6. The system of claim 1, wherein generating the one or more terms of offer associated with the request to sell a digital asset comprises receiving at least one of the one or more sale offer terms associated with the request to sell the digital asset from the original or current owner of the digital asset.

7. The system of claim 1, wherein verifying that the offer to purchase the digital asset conforms to the one or more sale offer terms comprises facilitating electronic negotiation between a seller of the digital asset and the prospective buyer of the digital asset.

8. The system of claim 1, wherein generating the one or more terms of offer associated with the request to sell a digital asset comprises accessing data previously stored in a distributed ledger.

9. The system of claim 1, wherein at least a portion of the information associated with the digital asset stored in the distributed ledger is stored in an encrypted format.

10. A method of facilitating the sale of a digital asset comprising:
receiving a request to sell the digital asset;
generating one or more sale offer terms associated with the request to sell the digital asset;
receiving an offer to purchase the digital asset from a prospective buyer;
verifying that the offer to purchase the digital asset conforms to the one or more sale offer terms;
facilitating the purchase of the digital asset at least in part by executing a smart contract on a distributed ledger, the smart contract comprising at least one self-executing term;
storing information associated with the sale of the digital asset in the distributed ledger.

11. The method of claim 10, wherein facilitating the purchase of the digital asset comprises enabling the purchase of the digital asset through an escrow service.

12. The system of claim 11, wherein enabling the purchase of the digital asset through an escrow service comprises:
locking electronic access to the digital asset;
receiving a payment for the purchase of the digital asset;
verifying that at least one of the one or more sale offer terms has been satisfied;
holding the payment for the purchase of the digital asset in the escrow service at least until completing the verification that at least one of the one or more sale offer terms has been satisfied;
releasing the payment to a seller of the digital asset; and
enabling electronic access to the digital asset to the purchaser of the digital asset.

13. The method of claim 10, wherein storing information associated with the sale of the digital asset comprises storing, in the distributed ledger, information related to a chain of ownership of the digital asset.

14. The method of claim 10, wherein verifying that the offer to purchase the digital asset conforms to the one or more sale offer terms comprises:
facilitating electronic negotiation between a seller of the digital asset and the prospective buyer of the digital asset; and
adjusting at least one term of the offer to purchase the digital asset as a result of the negotiation.

15. The method of claim 10, wherein at least a portion of the information associated with the digital asset stored in the distributed ledger is stored in an encrypted format.

16. The method of claim 10, wherein the smart contract is at least partially executed on a virtual machine.

17. One or more computer-readable media storing instructions that, when executed by one or more computer processors of a computing system, case the computing system to:
receive a request to sell the digital asset;
generate one or more sale offer terms associated with the request to sell the digital asset;
receive an offer to purchase the digital asset from a prospective buyer;
verify that the offer to purchase the digital asset conforms to the one or more sale offer terms;
facilitate the purchase of the digital asset at least in part by executing a smart contract on a distributed ledger, the smart contract comprising at least one self-executing term;
store information associated with the sale of the digital asset in the distributed ledger.

18. The computer-readable media of claim 17, wherein enabling the purchase of the digital asset through an escrow service comprises:
locking electronic access to the digital asset;
receiving a payment for the purchase of the digital asset;
verifying that at least one of the one or more sale offer terms has been satisfied;
holding the payment for the purchase of the digital asset in the escrow service at least until completing the verification that at least one of the one or more sale offer terms has been satisfied;
releasing the payment to a seller of the digital asset; and
enabling electronic access to the digital asset to the purchaser of the digital asset.

19. The computer-readable media of claim 17, wherein storing information associated with the sale of the digital asset comprises storing, in the distributed ledger, information related to a chain of ownership of the digital asset.

20. The computer-readable media of claim 17, wherein generating the one or more terms of offer associated with the request to sell a digital asset comprises accessing data previously stored in a distributed ledger.
